(19) United States
(12) Patent Application Publication
(10) Pub. No.: US 2012/0301391 A1
(43) Pub. Date: Nov. 29, 2012

(54) PROCESS FOR THE PRODUCTION OF HYDROGEN STARTING FROM LIQUID HYDROCARBONS, GASEOUS HYDROCARBONS AND/OR OXYGENATED COMPOUNDS ALSO DERIVING FROM BIOMASSES

(75) Inventors: Luca Eugenio Basini, Milano (IT); Gaetano Iaquaniello, Roma (IT)

(73) Assignee: ENI S.p.A., ROMA (IT)

(21) Appl. No.: 13/516,482

(22) PCT Filed: Dec. 15, 2010
(86) PCT No.: PCT/EP2010/007772

§ 371 Date: Aug. 3, 2012

(30) Foreign Application Priority Data
Dec. 16, 2009 (IT) MI2009A 002199

(51) Int. Cl. C01B 3/32; C01B 3/48

(52) U.S. Cl. 423/652; 423/655

(57) ABSTRACT

The present invention relates to a process for the production of hydrogen starting from liquid hydrocarbons, gaseous hydrocarbons, and/or oxygenated compounds, also deriving from biomasses, and mixtures thereof. Said process is characterized in that it comprises a preheating section (200) of the reagents, a short contact time—catalytic partial oxidation section (101) to give synthesis gas, a thermal recovery section (201), a conversion section (102) of the carbon monoxide present in the synthesis gas to carbon dioxide by means of a Water Gas Shift reaction, a removal section of the carbon dioxide produced (104), a cooling and removal section of the condensate. Said process can possibly comprise a purification section of the hydrogen produced by means of Pressure Swing Adsorption (105) and generation of purge gas having a medium heat power. Said process also possibly comprises a hydrodesulphuration section of the reagents.

The present invention relates to a process for the production of hydrogen starting from liquid hydrocarbons, gaseous hydrocarbons, and/or oxygenated compounds, also deriving from biomasses, and mixtures thereof. Said process comprises:
i) a section for the production of synthesis gas by means of short contact time—catalytic partial oxidation (SCT-CPO),
ii) a section in which the water gas shift (WGS) reaction takes place,
iii) a section for the removal of the carbon dioxide produced, and possibly
iv) a separation/purification section of the hydrogen produced (PSA) having a purge gas as by-product at slightly superatmospheric pressure, with a heat power which is sufficiently high as to allow its use as fuel and/or in the fuel supply system of a plant.

Said process can possibly comprise a hydrodesulphuration section of said feedstock.

The most widely-used technology for the production of synthesis gas and subsequently of hydrogen is the Steam Reforming (SR) process. This technology transforms light desulphurated hydrocarbons, by reacting them with steam, in direct fired multitubular catalytic reactors, inserted in an oven, according to the reaction [1]:

CH₄+H₂O=CO+3H₂ΔH°=49.3 kcal/mole [1]

The combustion serves to provide heat to the reactions which are extremely endothermic. The hydrocarbons enter the reforming tubes after being mixed with significant quantities of steam (the [steam moles/carbon moles] ratio is typically higher than 2.5) and are transformed into a mixture prevalently containing H₂ and CO (synthesis gas). The catalysts used typically contain Nickel deposited on an oxide carrier. The inlet temperatures into the tubes are typically higher than 600° C., whereas the temperatures of the gases leaving the tubes are lower than 900° C. The pressure at which the SR process takes place typically ranges from 5 relative bar to 30 relative bar.

More specifically, the SR process takes place in a tubular reactor in which the tubes are inserted in a radiant chamber and in which the reaction heat is supplied through wall or vault burners. In the SR reactor, the reaction tubes have a diameter ranging from 3″ to 5″ and a length of 6 metres to 13 metres; said tubes are filled with catalyst and the mixture composed of hydrocarbons and steam passes through them.

In order to obtain the outlet temperatures of the synthesis gas within the range of [800-900]° C., the wall temperature of said tubes is about [100-150]° C. higher and that of the fumes generated by the burners is [1200-1300]° C. These tubes, constructed by fusion with special alloys having a high Cr and Ni content ([25-35]%), consequently represent a critical element of the technology. The necessity of avoiding impingement between the tubes and flames of the burners, which would lead to the instantaneous collapse of the tubes, requires their distancing and consequently an increase in the volume of the reforming oven. A further critical aspect of the SR process relates to the impossibility of using high-molecular-weight hydrocarbons, which can lead to the formation of carbonaceous residues with a reduction in the catalytic activity. As a result of this, the heat supplied to the outside of the tubes causes cracking phenomena of the hydrocarbons, with a further formation of carbonaceous residues, of which the most extreme consequence is the blockage of the reforming tubes and their breakage. The sulphurated compounds, if fed to the SR process, can also cause deactivation of the catalyst and create analogous consequences. For this reason, for the SR process, the feedstock must be hydro-desulphurated before being used.

From an operative point of view, in an environment such as a refinery, the management of an SR oven consequently creates a series of critical elements which are currently solved by a continual monitoring of the same.

Various configurations and technologies have been proposed for solving some of the critical aspects relating to the SR technology. One of these is represented by the short contact time—catalytic partial oxidation (SCT-CPO) process described in the patents MI93A001857, MI96A000690, MI2002A001133, MI2007A002209 and MI2007A002228 of L. Basini et al. In this technology, the hydrocarbons mixed with air and/or oxygen are passed over a suitable catalyst and transformed into synthesis gas. The reaction heat is generated inside the reactor, by balancing the total and partial oxidation reactions of the feedstock. When natural gas is used, the main reaction of the SCT-CPO process is represented by the equation [2]:

CH₄+½O₂=CO+2H₂ΔH°=−8.5 kcal/mole [2]

This reactor is extremely simplified in its constructive and operative principles. The reactor is of the adiabatic type with dimensions over two orders of magnitude lower than the SR reactor. The catalysts, moreover, are not deactivated (unlike what takes place in the SR process) even if there are sulphurated compounds in the feedstock; this allows a process architecture in which the hydro-desulphuration step can be avoided. The constructive simplicity and resistance of the catalyst to deactivation phenomena also allow a considerable management simplicity and reduced maintenance interventions. More specifically, it is indicated that to produce 55,000 Nm³/hour of hydrogen with the SR technology, an oven containing 178 catalytic tubes is necessary. It is also estimated that, in this case, the volume of catalyst required amounts to about 21 Tons. It is also specified that the reaction section and thermal recovery section from the fumes of the reforming oven have considerable dimensions and occupy a volume of approximately 11,000 m³. The same quantity of H₂ could, on the other hand, be produced by an SCT-CPO reactor and a thermal recovery section having a total volume of about 70 m³ and containing 0.85 Tons of catalyst.

In the SR process destined for the production of H₂, the synthesis gas leaving the reforming oven is shifted to a mixture of H₂ and CO₂ by reacting the CO with water vapour in one or more Water Gas Shift (WGS) reactors according to the reaction [3]:

CO+H₂O=CO₂+H₂ΔH°=−9.8 kcal/mole [3]

The H₂ is subsequently separated and purified typically using a Pressure Swing Adsorption (PSA) section. The latter exploits the different physisorption properties of the molecules on different kinds of materials. The PSA section therefore releases a stream of pure H₂ and a stream of low-pressure purge gas which mainly comprises CO₂, CH₄ and a part of the H₂ produced. Said purge gas which has a heat power (PCI) typically within the range of [2,000-2,500] kcal/kg, it is then fed again to the reformer oven supplying a part of the reaction heat. One of the disadvantages of the SR reaction is the export production of steam, i.e. an excess production of steam which cannot be recovered in the process and whose presence reduces the energy efficiency of the process itself.

A similar process scheme can also be used in the SCT-CPO technology destined for the production of H₂. In this case, however, the partial pressure of the CO₂ produced at the outlet of the WGS section is higher than that obtained in the SR process, and consequently not only the flow-rate of the gas to be purified is higher in PSA, but also the purge gas leaving the PSA has a lower heat power with respect to that obtained by means of SR. A purge gas with an excessively low heat power value cannot easily be used for the production of steam in a boiler.

An objective of the present invention is to provide a new process architecture which combines a SCT-CPO section, a WGS section and a CO₂ removal section in order to obtain a stream of H₂, with purity higher than 90% v/v, separated from a stream of pure CO₂. In a possible process configuration, in addition to the three previous sections, there is also a PSA section, situated after the CO₂ removal section. This PSA unit allows high-purity, H₂ and a purge gas with a medium heat power, to be obtained.

A further objective of the present invention is therefore to produce streams of high-purity H₂ and CO₂ and a purge gas leaving the PSA with a medium-high heat power (PCI), which is such as to allow it to be used directly, in combustion processes and/or introduced into the fuel supply system of a plant. Finally, specifically because the hydrodesulphuration step of the feedstock can be avoided, a further objective of the present invention is to allow the production of synthesis gas containing lower quantities of sulphurated compounds, which could be eliminated in the CO₂ removal step and/or in the possible PSA step.

The present invention relates to a process for the production of hydrogen starting from reagents comprising liquid hydrocarbons, gaseous hydrocarbons, and/or oxygenated compounds, also deriving from biomasses, and mixtures thereof, wherein the gaseous hydrocarbons are selected from the group comprising natural gas, liquefied petroleum gas, gaseous hydrocarbon streams coming from operative processes in refineries and/or any chemical plant and mixtures thereof, wherein the liquid hydrocarbons are selected from the group comprising naphthas, gas oils, high-boiling gas oils, light cycle oils, heavy cycle oils, deasphalted oils, and mixtures thereof, and wherein the oxygenated compounds are selected from the group comprising glycerine, triglycerides, carbohydrates, methanol, ethanol, and mixtures thereof, said process characterized in that it comprises:
a pre-heating section of the reagents, at a temperature ranging from 100 to 500° C.,
a short contact time—catalytic partial oxidation section, wherein said reagents react with an oxidant including oxygen, air or air enriched in oxygen, to provide synthesis gas,
a heat recovery section, including a boiler which generates steam thus cooling the synthesis gas produced,
a conversion section of carbon monoxide contained in the synthesis gas to carbon dioxide by means of a Water Gas Shift reaction,
a section for the removal of the carbon dioxide contained in the stream produced by the Water Gas Shift section,
a section for the cooling and removal of the condensate produced by the Water Gas Shift section.

A further embodiment of the present invention relates to a process as previously described possibly comprising a purification section of the hydrogen produced by means of Pressure Swing Adsorption and the generation of purge gas having a medium heat power.

The purge gas can possibly be used in a combustion process and/or be introduced into the fuel supply system of a refinery or any other chemical plant. Having considerably reduced the flow-rate to the PSA, thanks to the removal of the CO₂, the possible final purification of the hydrogen is more efficient and less costly. Furthermore, this process greatly reduces emissions such as NOx, CO and particulates, as the preheating of the feedstocks can preferably be effected with the steam produced by the cooling of the synthesis gas leaving the SCT-CPO reactor. Process schemes which adopt the synthesis gas production technology via SCT-CPO may also not use preheating ovens of the reagents; it is therefore always possible to avoid producing diluted streams of CO₂ in the combustion fumes.

Finally, the process configuration can be such as to not cause the production of an excess of steam. The export of steam, in fact, is not always advantageous and in some cases it may be advisable to avoid it.

A further embodiment of the present invention relates to a process as previously described which possibly comprises a hydrodesulphuration section of the reagents.

The process integration between the hydrodesulphuration section, SCT-CPO, WGS reaction, CO₂ removal and PSA can also be formulated so as to not cause any emission of CO₂ in diluted streams different from that obtained from the removal unit. The SR technology, on the contrary, does not allow a process scheme to be formulated in which an overproduction of steam (we repeat that the export of steam in fact is not always advantageous or necessary in all industrial contexts) or the emission of CO₂ in the fumes of the preheating and SR ovens, can be avoided. The quantity of CO₂ emitted and “not recoverable” corresponds to percentages ranging from 30% v/v to 45% v/v of the total quantity of CO₂ produced.

All of these advantages together make the production cost of hydrogen in different scenarios more competitive with respect to that which can be obtained with the conventional SR technology.

Further objectives and advantages of the present invention will appear more evident from the following description and enclosed drawings, provided for purely illustrative and non-limiting purposes.

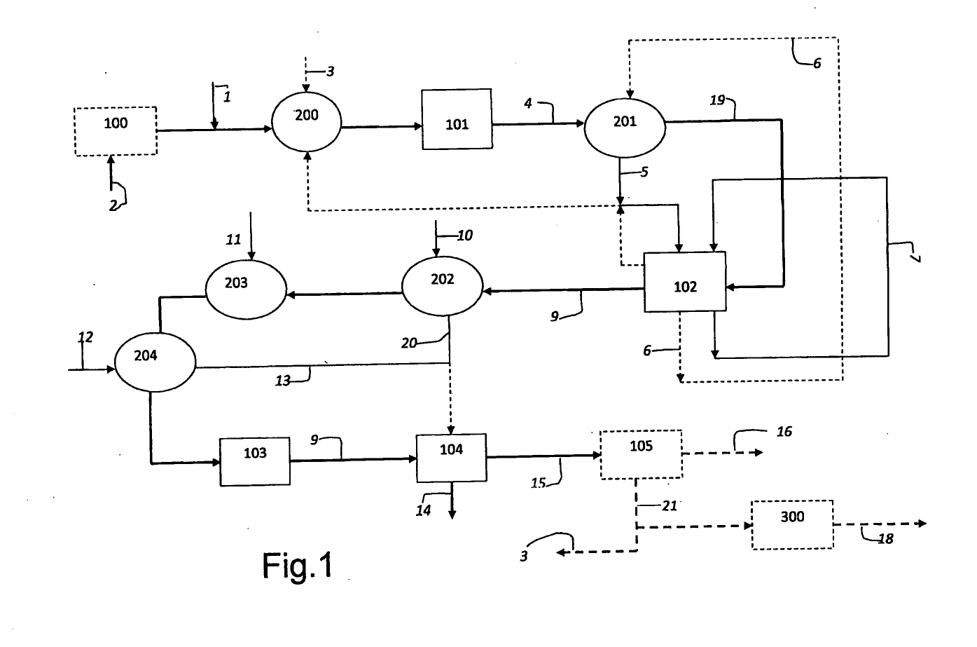

FIG. 1 shows a block scheme of the production process of hydrogen in which:
100 is the hydrodesulphuration section,
200 is the preheating section of the feeding,
101 is the SCT-CPO reaction section,
201 is the thermal recovery boiler,
102 is the section in which the Water Gas Shift (WGS) reaction takes place,
202 is a Boiling Feed Water (BFW) cooler,
103 is the condensate removal area,
104 is the CO₂ removal section,
105 is the PSA section,
300 is the purge gas compression.

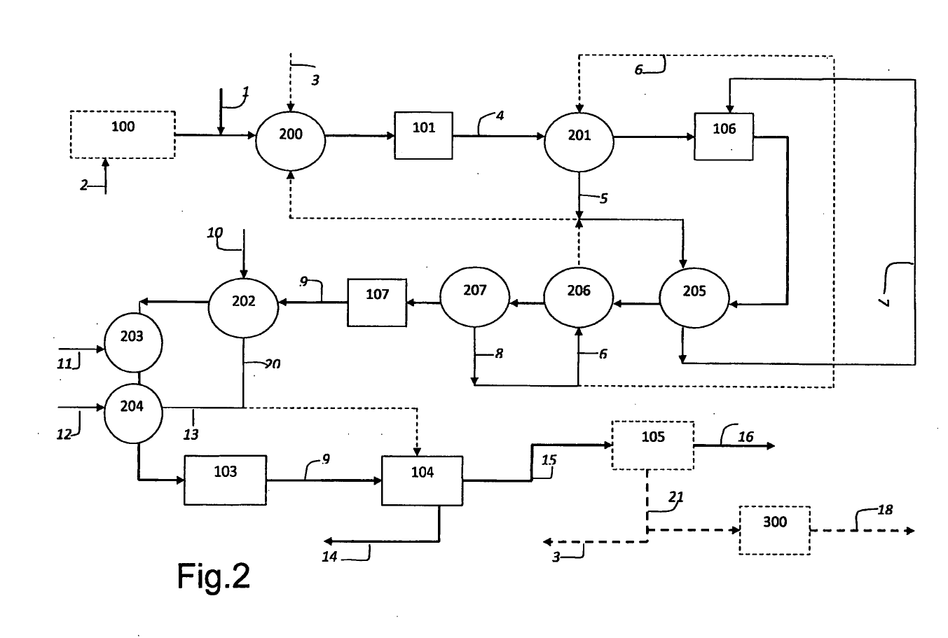

FIG. 2 shows a block scheme of the production process of hydrogen similar to FIG. 1 except for the block P (WGS) which in this figure comprises:
106 is a high-temperature shift (HTS) reaction section,
107 is a low-temperature shift (LTS) reaction section,
206 is a steam generator,
205 is a steam overheater,
207 is a Boiling Feed Water (BFW) cooler.

205 and 206 obtain the production of steam to be exploited in the process.

According to what is represented in FIG. 1, the feeding (2) is possibly hydro-desulphurated, it is subsequently mixed with the oxidant (1) and preheated before reacting in a catalytic partial oxidation section (101) in which the reagents are converted into synthesis gas (4). The hot synthesis gas is cooled by means of a heat recovery boiler (201) and the high-temperature steam (5) thus produced is possibly used partly for the preheating phase of the reagents (200), and partly for sustaining the Water Gas Shift reaction (102). The cooled synthesis gas (19) is converted in the WGS section (102) into the mixture comprising hydrogen and carbon dioxide (9). Said mixture is cooled by means of a Boiling Feed Water cooler (202) and a water exchanger (204) thus producing low-pressure steam (13 and 20). The cooling is completed with an air exchanger (203). After cooling, a separator (103) removes the condensate and the mixture thus obtained enters a CO₂ removal section (104). If this section functions with an amine solution, part of the low-pressure steam produced (13 and 20) can possibly be used for washing said solution. A stream of H₂ (15) and a stream of CO₂ (14) leave 104. The hydrogen enters a possible purification section (105) from which pure hydrogen (16) exits together with purge gas (21), which can be used partly as fuel in the possible preheating oven of the reagents (3) and can be partly compressed for other purposes (300).

### DETAILED DESCRIPTION

With reference to FIG. 1, the process, object of the present invention, comprises the phases described hereunder.

The feeding (2) comprises liquid hydrocarbons, gaseous hydrocarbons, and/or oxygenated compounds, also deriving from biomasses, and mixtures thereof. The gaseous hydrocarbons comprise natural gas, liquefied petroleum gas, gaseous hydrocarbon streams coming from operative processes in refineries and/or any chemical plant and mixtures thereof. The liquid hydrocarbons comprise naphthas, gas oils, high-boiling gas oils, light cycle oils, heavy cycle oils, deasphalted oils, and mixtures thereof.

The oxygenated compounds comprise glycerine, triglycerides, carbohydrates, methanol, ethanol and mixtures thereof.

The feeding (2) possibly enters the hydrodesulfphuration section (100) where the sulphur is initially converted to sulphidric acid and is subsequently reacted with zinc oxide so that the outgoing feedstock contains less than 0.1 ppm of sulphur. The hydrodesulfphuration section may not be the initial step of the process as the catalytic partial oxidation section (101) is capable of also operating with sulphurated feedstocks. The hydrodesulfphuration section (100) can be situated downstream of a Water Gas Shift Sulphur Tolerant section (not indicated in FIG. 1). The stream leaving the hydrodesulfphuration section is mixed with the oxidant (1), selected from oxygen, air and air enriched in oxygen. Said mixture is preheated (200) to a temperature ranging from 100° C. to 500° C. before entering the short contact time—catalytic partial oxidation section (101). The preheating can possibly take place in an oven exploiting a part of the purge gas generated (3). The preheating (200) preferably exploits a part of the steam produced in the process itself (5). In the short contact time—catalytic partial oxidation section (101), the hydrocarbon compounds and/or oxygenated compounds react with the oxidant to give synthesis gas (4), i.e. a mixture of hydrogen and carbon monoxide. The preferred operative conditions in a short contact time—catalytic partial oxidation reactor are:
inlet temperature ranging from 100 to 450° C.,
steam/carbon ratio in the feed ranging from 0 v/v to 2 v/v, more preferably ranging from 0.2 v/v to 1.0 v/v,
O₂/carbon ratio in the feed ranging from 0.40 v/v to 0.70 v/v, more preferably ranging from 0.5 v/v to 0.60 v/v,
GHSV space velocity ranging from 10,000 hr⁻¹ to 500,000 hr⁻¹, preferably ranging from 30,000 hr⁻¹ to 250,000 hr⁻¹ and more preferably ranging from 45,000 hr⁻¹ to 200,000 hr⁻¹, wherein GHSV is defined as an hourly volumetric flow of gaseous reagents divided by the volume of catalyst,
outlet temperature from the reactor ranging from 500 to 1,100° C., preferably from 650° C. to 1,050° C. and more preferably ranging from 750° C. to 1,000° C. The catalytic partial oxidation reaction is exothermic, it is therefore preferable to recover the heat transported by the synthesis gas through a boiler in which water (6) enters (possibly generated in the process) and from which high-temperature steam exits (H.T. Steam or 5). A part of the high-temperature (H.T.) steam is preferably used for:
   preheating the reagent mixture before the SCT-CPO section (101),
   contributing to the overheated steam cycle generated in the WGS section (102).

More specifically, as far as the steam cycle is concerned, it has been observed that a part of the H.T. Steam (5), generated in the cooling of the stream of synthesis gas produced (4), is injected into the WGS section (102) to guarantee high conversions of the carbon monoxide and allow the formation of H₂ and CO₂ (9). The mixture obtained after the WGS reaction is cooled producing low-pressure steam (13 and 20), a part of which can preferably supply the heat necessary for the regeneration section of the amines possibly used in the CO₂ removal section (104). In a further phase, the mixture of H₂ and CO₂ is cooled with water by means of a Boiling Feed Water cooler (202) and is then cooled with an air exchanger (203) and with a water exchanger (204) before being sent to a section which removes the condensate (103). After removing the condensates, the gas (9) is sent to the carbon dioxide removal section (104). The CO₂ removal section preferably includes an amine washing section, but it can also include any other system. This section preferably removes at least 98% of the carbon dioxide contained in the synthesis gas. After the removal of the CO₂, the gaseous stream obtained contains a high percentage of H₂, preferably higher than 80% v/v, but even more preferably higher than 90% v/v, said stream can be treated by a PSA section having reduced dimensions (105). Said PSA section allows a high recovery factor of the H₂ produced (16) to be obtained, higher than 85% v/v and preferably higher than 90% v/v. The total or almost total lack of CO₂ in the stream which can be sent to the PSA significantly increases the heat power of the purge stream allowing it to be re-used in combustion processes and/or to be introduced into the fuel supply system of a refinery or any other chemical plant. In a preferred embodiment, part of the purge gas (3) is used as fuel for a preheating oven of the reagents (200), before entering the SCT-CPO section. The purge gas separated by means of PSA, in fact, has a relatively high heat power, with a value at least equal to 4,000 kcal/kg, preferably ranging from 4,500 kcal/kg to 7,000 kcal/kg and even more preferably ranging from 5,000 kcal/kg to 6,000 kcal/kg.

### Example 1

Table 1 compares the consumptions of two typical Steam Reforming and SCT-CPO plants, both structured for recovering CO₂. The comparison is centred on the analysis effected for plants with a capacity of 55,000 Nm³/hour of H₂. Example 1 refers to FIG. 2. The specific consumptions indicated in Table 1 were evaluated using, for Steam Reforming, the data indicated by the licensees, whereas for the SCT-CPO technology have been reported the consolidated data at a bench and pilot scale level. Information relating to widely-diffused technologies was also used for the other units in the hydrodesulfphuration (100), WGS (106, 205, 206, 207 and 107), PSA (105) and CO₂ removal (104) sections. The electric consumptions for the compression operations and separation of the oxygen in the Air Separation Unit have not been inserted.

TABLE 1
Comparison SR vs. SCT-CPO

| Specific consumptions | Steam Reforming | SCT-CPO |
|---|---|---|
| NATURAL GAS FEEDSTOCK¹ | 100 | 96 |
| FUEL GAS TO THE BURNERS | 100 | 0 |
| DEMI WATER | 100 | 84 |
| COOLING WATER | 100 | 95 |
| ELECTRIC ENERGY | 100 | 95 |
| AMMONIA SOLUTION | 100 | Not required |
| EXPORT NITROGEN | Not available | Available |
| CO2 EMISSION PENALIZATION | 100 | 10 |
| LOW PRESSURE STEAM IMPORT | Required | Not required |

¹Calculated by subtracting the heat of the purge gas.

From a comparison between the total and specific consumptions, an extremely favourable situation emerges for the SCT-CPO technology if compared with the SR technology in the presence of CO₂ recovery. More specifically, it can be noted that the consumptions of natural gas or rather the calories input per unit of product proves to be almost 4% lower for the SCT-CPO technology, with an emission of CO₂ ten times lower, which leads this technology to be considered a winning choice when a CO₂ recovery is to be installed. There are evident economical advantages which are even more so in contexts which jeopardize the production of CO₂ and reward its “sequestration” and re-use.

It should be pointed out that in SR, an important part of the CO₂, approximately a third, remains in the fumes and its recovery creates problems which are difficult to solve technically (degradation of the adsorbing solutions in the presence of oxygen) and which imply operative costs which are so high as to make this solution not to be proposable. In SR, a total recovery of the CO₂ is consequently unconceivable as it can be done in the SCT-CPO where all the CO2 is present in the process gas.

The SCT-CPO technology, on the contrary, is jeopardized by a higher consumption of cooling water and electric consumption relating to the cryogenic unit for separating the air and obtaining pure oxygen. Between the two, the cost of electric energy is almost two orders of magnitude higher. The advantage of the SCT-CPO technology is consequently greater in countries in which the energy cost is lower. It should be noted that the advantage with respect to consumptions is additional to that relating to the investment costs, as the complexity of the synthesis gas production section is considerably reduced passing from the SR technology to the SCT-CPO technology.

### Example 2

In this example, reference is again made to FIG. 2. In the example, the specific consumptions of two plants with a capacity of 55,000 Nm³/hour of H₂ were compared, which use process schemes which do not comprise PSA units and produce streams of H₂ with a lower purity. The volume percentage of the hydrogen present in the syngas at the battery limits of SCT-CPO is 91%, whereas that of SR is 92.7%.

The specific consumptions were again evaluated using, for Steam Reforming, the data indicated by the licensees, and for the SCT-CPO technology, the consolidated data at a bench-scale level. The electric consumptions for the compression operations and separation of the oxygen in the Air Separation Unit are not included.

TABLE 2
Comparison SR vs. SCT-CPO.

| Specific consumptions | Steam Reforming | SCT-CPO |
|---|---|---|
| NATURAL GAS FEEDSTOCK¹ | 100 | 98 |
| DEMI WATER | 100 | 84 |
| COOLING WATER | 100 | 95 |
| ELECTRIC ENERGY | 100 | 95 |
| AMMONIA SOLUTION | 0.001 | |
| EXPORT NITROGEN | Not available | Available |
| IMPORT STEAM B.P. | Required | |
| CO2 EMISSION PENALIZATION | 100 | 9 |

¹Calculated by summing the natural gas at the burners.

As for Example 1, the process configuration adopted for the SCT-CPO process is clearly more advantageous in contexts in which the “sequestration” and re-use of CO₂ is rewarding and in contexts in which the cost of electric energy is low.

Furthermore, in this case, the percentage reduction in the investment costs relating to the reduction in the complexity of the synthesis gas production section of the SCT-CPO process increases with respect to the SR process.

1. A process for producing hydrogen, comprising:
pre-heating reagents, at a temperature of from 100 to 500° C.,
oxidizing the reagents in a short contact time catalytic partial oxidation, wherein the reagents react with an oxidant comprising oxygen, air, or air enriched in oxygen, thereby obtaining a synthesis gas,
recovering the synthesis gas in a heat recovery, comprising a boiler which generates steam, thus cooling the synthesis gas,
converting carbon monoxide in the synthesis gas to carbon dioxide via a Water Gas shift reaction, thereby obtaining a stream comprising carbon dioxide,
removing the carbon dioxide from the stream, and
cooling and removing a condensate of the Water Gas Shift reaction,
wherein an inlet temperature of the short contact time catalytic partial oxidation is from 100 to 450° C.,
a Steam/Carbon ratio in the reagents of the short contact time catalytic partial oxidation is from 0 v/v to 2 v/v,
an O₂/Carbon ratio in the reagents of the short contact time catalytic partial oxidation is from 0.40 v/v to 0.70 v/v,
a GHSV space velocity of the short contact time catalytic partial oxidation is from 10,000 hr⁻¹ to 500,000 hr⁻¹,
a reactor outlet temperature of the short contact time catalytic partial oxidation is from 500° C. to 1,100° C.,
the reagents comprise a liquid hydrocarbon, a gaseous hydrocarbon, an oxygenated compound, or any combination thereof,
the reagents derive from a biomass, or a mixture thereof,
if the reagent comprises a gaseous hydrocarbon, the gaseous hydrocarbon is at least one selected from the group consisting of natural gas, liquefied petroleum gas, and a gaseous hydrocarbon stream from an operative processes in a refinery or any chemical plant,
if the reagent comprises a liquid hydrocarbon, the liquid hydrocarbon is at least one selected from the group consisting of a naphtha, a gas oil, a high-boiling gas oil, a light cycle oil, a heavy cycle oil, and a deasphalted oil,
if the reagent comprises an oxygenated compound, the oxygenated compound is at least one selected from the group consisting of glycerine, triglyceride, a carbohydrate, methanol, and ethanol.

2. The process of claim 1, wherein the pre-heating comprises heating the reagents in an oven.

3. The process of claim 2, wherein a fuel for the oven comprises a purge gas.

4. (canceled)

5. The process of claim 1,
wherein a Steam/Carbon ratio in the reagents of the short contact time catalytic partial oxidation is from 0.2 v/v to 1 v/v,
an O₂/Carbon ratio in the reagents of the short contact time catalytic partial oxidation is from 0.5 v/v to 0.60 v/v,
a GHSV space velocity of the short contact time catalytic partial oxidation is from 30,000 hr⁻¹ to 250,000 hr⁻¹,
a reactor outlet temperature of the short contact time catalytic partial oxidation is from 650° C. to 1,050° C.

6. The process of claim 5, wherein
a GHSV space velocity of the short contact time catalytic partial oxidation is from 45,000 hr⁻¹ to 200,000 hr⁻¹,
a reactor outlet temperature of the short contact time catalytic partial oxidation is from 750° C. to 1,000° C.

7. The process of claim 1, further comprising:
purifying hydrogen via a Pressure Swing Adsorption and
generating a discharge gas having a medium heat power.

8. The process of claim 1, further comprising hydrodesulphurating the reagents.

9. The process of claim 1, wherein removing the carbon dioxide comprises removing the carbon dioxide with an amine solution as washing solvent.

10. The process of claim 9, further comprising regenerating the amine solution with a steam from the process, thereby releasing a concentrated stream of carbon dioxide.

11. The process of claim 1, wherein pre-heating the reagent mixture before the oxidizing comprises pre-heating with a steam from the process.

12. The process of claim 1, further comprising adding a steam from the process to the reagent at an inlet of the Water Gas Shift reaction.

13. The process of claim 1, wherein removing the carbon dioxide obtains carbon dioxide that is at least 98% by volume.

14. The process of claim 1, wherein removing the carbon dioxide, comprises obtaining a gaseous stream with a H₂ percentage higher than 80% by volume.

15. The process of the claim 14, wherein the H₂ percentage is higher than 90% v/v.

16. The process of claim 7, wherein the purifying obtains a volume of H₂ higher than 85% v/v.

17. The process of claim 16, wherein the volume of H₂ is higher than 90% v/v.

18. The process of claim 1, wherein a purge gas leaving the purifying has a heat power of at least 4,000 kcal/kg.

19. The process of claim 18, wherein the heat power is from 4,500 kcal/kg to 7,000 kcal/kg.

20. The process of claim 19, wherein the heat power is from 5,000 kcal/kg to 6,000 kcal/kg.
